(19) United States
(12) Patent Application Publication
(10) Pub. No.: US 2005/0200753 A1
(43) Pub. Date: Sep. 15, 2005

(54) Image photographing apparatus

(75) Inventors: Chang-Hee Lee, Suwon-si (KR); Nam-Il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/049,934

(22) Filed: Feb. 4, 2005

(30) Foreign Application Priority Data
Mar. 10, 2004 (KR) 2004-16039

(51) Int. Cl. H04N 5/225

(52) U.S. Cl. 348/376

(57) ABSTRACT

An image photographing apparatus having a grip cover and a grip cover mount part on a deck door, for mounting the grip cover. The apparatus comprises a prominence, a depression and a hook on the grip cover, for holding the apparatus. An adjustment hole is configured on the grip cover mount part to releasably engage the grip cover with the hook and adjust a travel system adjustment member.

### CROSS-REFERENCE TO RELATED APPLICATIONS

This application claims the benefit under 35 U.S.C. § 119(a) of Korean Patent Application No. 2004-16039, entitled “Image Photographing Apparatus,” filed on Mar. 10, 2004, the entire contents of which are hereby incorporated by reference.

### BACKGROUND OF THE INVENTION

1. Field of the Invention

The present invention relates to an image photographing apparatus capable of storing and reproducing a photographed image. More particularly, the present invention relates to a image photographing apparatus having an ergonomically configured gripping cover and an adjustable magnetic tape travel system.

2. Description of the Related Art

Image photographing apparatuses, such as camcorders and digital cameras, are widely used. Image photographing apparatuses have deck units for recording and reproducing images or sounds of objects being photographed to a recording media such as a tape. The deck unit has a travel system for the magnetic tape and a head drum.

Generally, a user holds an image photographing apparatus in one hand during a photographing operation. Thus, image photographing apparatuses may be cumbersome if used for extended periods of time. Therefore, comfort is of significant importance. A drawback of conventional image photographing apparatuses is inadequate gripping surfaces. In particular, user's often perspire while holding the image photographing apparatus, and experience discomfort.

Another problem with conventional image photographing apparatus is that components are often difficult to reach. For example, when assembly of the apparatus is complete, the travel system should be adjusted. In specific, posture and height of guide pole guiding travel of the tape or a guide roller should be adjusted. For the adjustment, a hole is necessary for allowing access to a travel system adjustment member. The travel system is adjusted through the hole. Subsequently, the hole is closed by a packing such as rubber. However, as the rubber packing is exposed, the aesthetics of the image are diminished. Furthermore, material is wasted. The rubber packing is press-fitted so that a general user does not remove the rubber packing. Therefore, the rubber packing is difficult to remove for repair or adjustment of the travel system.

Therefore, a need exists for a image photographing apparatus having improved structure for eliminating discomfort and an improved magnetic tape travel system adjustment member which is improved both operationally and aesthetically.

### SUMMARY OF THE INVENTION

Accordingly, embodiments of the present invention have been conceived to solve the above-mentioned problems occurring in the prior art, and an aspect of the present invention is to provide an image photographing apparatus having a developed structure for improving a user's comfort, the aesthetics of the apparatus, and facilitating adjustment of the magnetic tape travel system.

The foregoing and other objects are substantially realized by providing an image photographing apparatus comprising a main body having an outside surface, a deck unit for recording and reproducing information on a magnetic tape, a grip cover removeable engageable with the outside surface of the main body for facilitating gripping of the apparatus, and a plurality of prominences and depressions disposed on an outside surface of the grip cover, providing a gap between the user's hand and the outside surface of the grip cover for facilitating air flow.

The main body of the image photographing apparatus also includes a first camera unit for photographing a movable image. A second camera unit is provided for photographing a still image. Additionally, a deck unit is included for recording and reproducing information to a magnetic tape, a grip cover engages with the outside surface of the main body for facilitating gripping of the apparatus by a user's hand, and a plurality of prominences and depressions are disposed on an outside surface of the grip cover. The prominences and depressions provide a gap between the user's hand and the outside surface of the grip cover for facilitating air flow.

An exemplary embodiment of the invention has a main body including an outside surface, a deck unit for recording and reproducing information to a magnetic tape, and a deck door for insertion and withdrawal of the magnetic tape within the deck unit. A grip cover is mounted to one side of the deck door, the deck door and the grip cover are movably positionable with respect to the outside surface of the main body for facilitating gripping of the apparatus by a user's hand. A plurality of prominences and depressions are disposed on an outside surface of the grip cover for providing a gap between the user's hand and the outside surface of the grip cover for facilitating air flow.

The prominences and depressions may comprise a plurality of ribs.

The main body may comprise an movable deck door for insertion and withdrawal of the magnetic tape, and the grip cover may be mounted to one side of the deck door.

At least one adjustment hole extends through the deck door to adjust a magnetic tape travel system of the deck unit, and the adjustment hole may be covered or uncovered by the grip cover.

The grip cover may have a hook disposed thereon for engagement with the adjustment hole; and a screw hole for releasably attaching the grip cover to the main body by a fastener.

At least one adjustment hole extends through the main body to adjust a magnetic tape travel system of the deck unit, and the adjustment hole may be covered with the grip cover.

The grip cover may have a hook disposed thereon for engagement with the adjustment hole; and a screw hole for releasably attaching the grip cover to the deck door by a fastener.

The main body of an image photographing apparatus according to an embodiment may comprise a first camera unit for photographing a movable image and a second camera unit for photographing a still image.

Other objects, advantages, and salient features of the invention will become apparent from the detailed description, which, taken in conjunction with the annexed drawings, discloses preferred embodiments of the invention.

### BRIEF DESCRIPTION OF THE DRAWINGS

The above and other aspects, features and advantages of certain embodiments of the present invention will be more apparent from the following detailed description taken with reference to the accompanying drawings, in which:

FIG. 1 is a perspective view of an image photographing apparatus in accordance with an embodiment of the present invention;

FIG. 2 is a perspective view of a grip cover attached to the image photographing apparatus of FIG. 1;

FIG. 3 is a sectional view of line I-I of FIG. 1;

FIG. 4 is a perspective view of the image photographing apparatus as shown in FIG. 1, showing a deck unit;

FIG. 5 is a perspective view of the image photographing apparatus of FIG. 1, with a deck door open.

Throughout the drawings, the same drawings reference numerals will be understood to refer to the same elements, features, and structures.

### DETAILED DESCRIPTION OF EXEMPLARY EMBODIMENTS

The matters defined in the description such as a detailed construction and elements thereof, are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness.

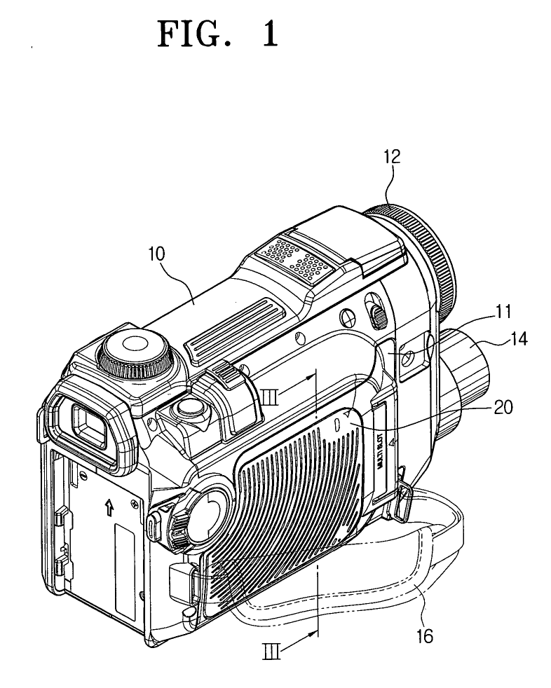

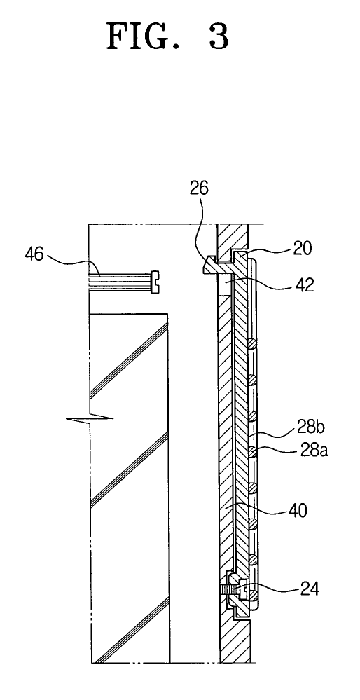

Referring to FIGS. 1-4, an image photographing apparatus according to an embodiment of the present invention comprises a main body 10, a grip cover 20 and a deck door 11.

The main body 10 comprises a first camera unit 12 (hereinafter called as a camcorder unit), a second camera unit 14 (hereinafter called a digital camera unit) and a holding band 16.

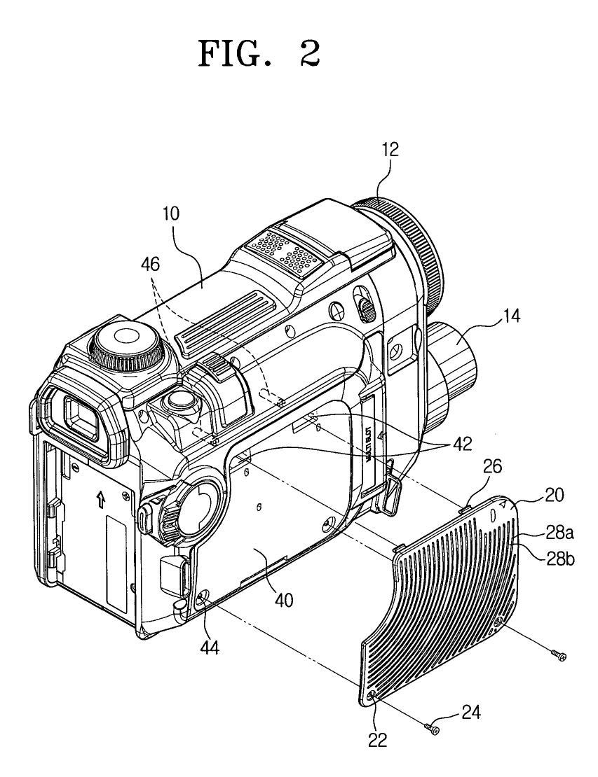

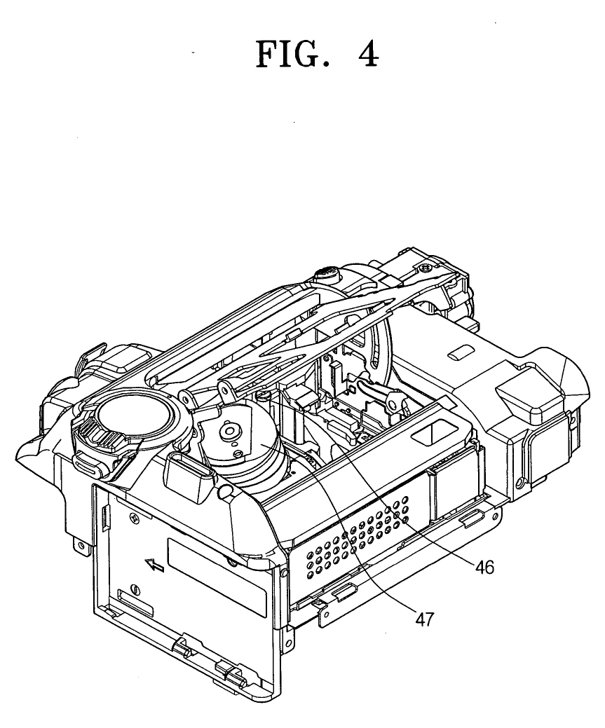

As seen in FIGS. 2 and 4, the camcorder unit 12 has a deck unit (not shown), and the deck unit has a travel system adjustment member 46 and a head drum 47 therein.

The travel system adjustment member 46 comprises a guide pole and a guide roller, and the travel system adjustment guides a magnetic tape to the head drum 47. The travel system adjustment member 46 is adjusted so that the magnetic tape may be more precisely guided to the head drum 47. A groove is formed at an end of the travel system adjustment member 46 such that the travel system adjustment member 46 may be rotated by a tool such as a conventional screwdriver to adjust the height of the travel system adjustment member 46.

A conventional head drum 47, as understood by one having ordinary skill in the art, has a function of reading or storing data in the magnetic tape.

The digital camera unit 14 photographs moving images and still images to store the images on a recording media for outputting. Conventional storing media, such as a hard disk (not shown) or a memory card (not shown), is used. The detailed description thereof is omitted since storage media suitable for digital camera units 14 are well known to those having ordinary skill in the art.

A conventional holding band 16 is configured from one side to the other side of a main body 10. The holding band 16 firmly holds the user's hand on the image photographing apparatus.

Referring to FIG. 2, the grip cover 20 comprises a first screw hole 22, a fastening member 24, a hook 26 and a prominence 28a and depression 28b.

Two first screw holes 22 extend through a bottom side of the grip cover 20. A screw thread is formed in the first screw hole 22 for engagement with a screw.

The fastening member 24 is inserted through the first fastening hole 22 and also a second fastening hole 44, (which will be explained further below), to mount and fix the grip cover 20 to the grip cover mount part 40. A screw is generally used as the fastening member 24.

A hook 26 is configured on one side of the grip cover 20 and engages adjustment hole 42 as will be explained further below. The hook 26 and the adjustment hole 42 are provided in corresponding numbers for engagement with one another.

The prominence 28a and depression 28b are integrally disposed with an outside surface of grip cover 20. The prominence 28a and depression 28b may be configured in the form of embossing ribs as shown in FIG. 1. However, any other suitable shapes and patterns may be used. Color and material may also be changed depending on user's needs. The prominence 28a and depression 28b is contacted with a user's hand when the user holds an image photographing apparatus. A gap between the user's hand and the grip cover 20 is generated by the prominence 28a and depression 28b, so that air flows through the gap to prevent user perspiration. Preferably, for improved ventilation, the prominence 28a and depression 28b may comprise a plurality of regularly-spaced ribs.

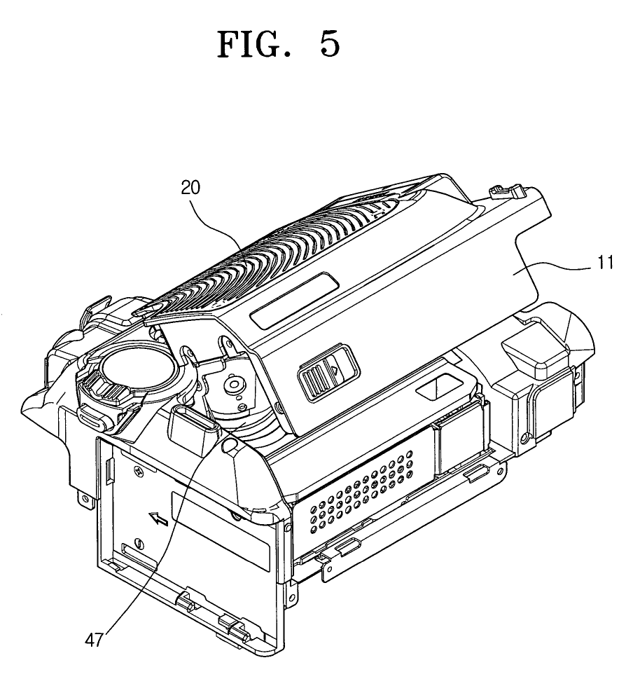

The deck door 11 has a grip cover mount part 40, and the grip cover mount part 40 comprises the adjustment hole 42 and the second fastening hole 44. The deck door 11 is movably positioned on a side of the main body 10, and is capable of being opened and closed as shown in FIG. 5. Accordingly, a user can insert and withdraw a magnetic tape into/from the camcorder unit 12 after the deck door 11 is opened.

The grip cover mount part 40 is recessed on one side of the deck door 11 and corresponds to the grip cover 20 such that the grip cover 20 may be easily attached. The adjustment hole 42 is provided on the grip cover mount part 40 for adjusting the travel system adjustment member 46 from the outside.

As stated above, the adjustment hole 42 is extends through the grip cover mount part 40 for adjusting the travel system adjustment member 46 from the outside. Additionally, the adjustment hole 42 is configured to correspond to the counterpart hook 26 for engagement.

The second screw hole 44 is formed on the grip cover mount part 40, and corresponds with the first screw hole 22, so that fastening member 24 is inserted in the second screw hole 44. A screw thread may be formed along the second screw hole 44.

Hereinafter, the operation of the present invention will be in detail described.

An image photographing apparatus according to an embodiment of the present invention has a travel system adjustment member for facilitating adjustment of the travel system after assembly. After assembly, the travel system adjustment member 46 may be adjusted via the hook hole 42 on the grip cover mount part 40. A groove is formed at the upper part of the travel system adjustment member 46, and the travel system adjustment member 46 is rotated via the groove by a tool such as a conventional screwdriver to adjust the height thereof.

The travel system is adjusted as stated above, and the grip cover 20 is mounted to the grip cover mount part 40. The hook 26 is engaged within the adjustment hole 42. The fastening member 24 is inserted to the first screw hole 22 and the second screw hole 44 so that the grip cover 20 is mounted and fixed to the grip cover mount part 40. At this time, the adjustment hole 42 is covered with the grip cover 20. Accordingly, the press-fit of a rubber packing required on conventional apparatus is not required, and the rubber packing member may also be omitted. Additionally, if it is necessary that the travel system need future repairs or maintenance, conventional press-fit packing need not be forcedly removed. Therefore, embodiments of the present invention provide an image photographing apparatus that may easily adjust a travel system through the adjustment hole 42 by unfastening fastening member 24.

A user generally holds an image photographing apparatus in one hand during photographing operation. The photographing often lasts more than one hour. If a user holds the image photographing apparatus for a long time, a user's hand often perspires while holding the image photographing apparatus. An image photographing apparatus according to an embodiment of the present invention has prominences 28a and depressions 28b on grip cover 20 to generate a space between the user's hand and the grip cover 20. Accordingly, air flow is facilitated for eliminating discomfort caused by perspiration.

As described above, in an image photographing apparatus according to an embodiment of the present invention, a grip cover 20 covers a adjustment hole 42 for adjusting a travel system, and therefore, a conventional press-fitting process of a rubber packing can be omitted and producing process can be simplified. Additionally, a travel system can be easily adjusted since only grip cover 20 is separated.

Even when a user holds an image photographing apparatus for a long time, spaces formed between the prominences 28a and depressions 28b on the grip cover, allow air to circulate and prevent a user's hand from perspiring.

While the invention has been shown and described with reference to certain embodiments thereof, it will be understood by those skilled in the art that various changes in form and details may be made therein without departing from the spirit and scope of the invention as defined by the appended claims.

1. An image photographing apparatus comprising
a main body having an outside surface;
a deck unit for recording and reproducing information to a magnetic tape;
a grip cover removeably engaged with the outside surface of the main body for facilitating gripping of the apparatus by a user's hand; and
a plurality of prominences and depressions disposed on an outside surface of the grip cover, providing a gap between the user's hand and the outside surface of the grip cover for facilitating air flow.

2. The image photographing apparatus of claim 1, wherein the prominences and depressions comprise a plurality of ribs.

3. The image photographing apparatus of claim 1, wherein the main body comprises a movable deck door for insertion and withdrawal of the magnetic tape, and the grip cover is mounted to one side of the deck door.

4. The image photographing apparatus of claim 3, wherein at least one adjustment hole extends through the deck door to adjust a magnetic tape travel system of the deck unit, and the adjustment hole is covered and uncovered by the grip cover.

5. The image photographing apparatus of claim 4, wherein the grip cover comprises:
a hook disposed thereon for engagement with the adjustment hole; and
a screw hole for releasably attaching the grip cover to the deck door by a fastener.

6. The image photographing apparatus of claim 1, wherein at least one adjustment hole extends through the main body to adjust a magnetic tape travel system of the deck unit, and the adjustment hole may be covered or uncovered by the grip cover.

7. The image photographing apparatus of claim 6, wherein the grip cover comprises:
a hook disposed thereon for engagement with the adjustment hole; and
a screw hole for releasably attaching the grip cover to the deck door by a fastener.

8. The image photographing apparatus according to claim 1, wherein the main body of the image photographing apparatus comprises a first camera unit for photographing a movable image; and a second camera unit for photographing a still image.

9. An image photographing apparatus comprising:
a main body having an outside surface, the main body of the image photographing apparatus comprises a first camera unit for photographing a movable image; and a second camera unit for photographing a still image;
a deck unit for recording and reproducing information to a magnetic tape;
a grip cover engaged with the outside surface of the main body for facilitating gripping of the apparatus by a user's hand; and
a plurality of prominences and depressions disposed on an outside surface of the grip cover, providing a gap between the user's hand and the outside surface of the grip cover for facilitating air flow.

10. The image photographing apparatus of claim 9, wherein the prominences and depressions comprise a plurality of ribs.

11. The image photographing apparatus of claim 9, wherein the main body comprises a movable deck door for insertion and withdrawal of the magnetic tape, and the grip cover is mounted to one side of the deck door.

12. The image photographing apparatus of claim 11, wherein at least one adjustment hole extends through the deck door to adjust a magnetic tape travel system of the deck unit, and the adjustment hole is covered and uncovered by the grip cover.

13. The image photographing apparatus of claim 12, wherein the grip cover comprises:
a hook disposed thereon for engagement with the adjustment hole; and
a screw hole for releasably attaching the grip cover to the deck door by a fastener.

14. The image photographing apparatus of claim 9, wherein at least one adjustment hole extends through the main body to adjust a magnetic tape travel system of the deck unit, and the adjustment hole may be covered or uncovered by the grip cover.

15. The image photographing apparatus of claim 14, wherein the grip cover comprises:
a hook disposed thereon for engagement with the adjustment hole; and
a screw hole for releasably attaching the grip cover to the deck door by a fastener.

16. An image photographing apparatus comprising:
a main body having an outside surface;
a deck unit for recording and reproducing information to a magnetic tape;
a deck door for insertion and withdrawal of the magnetic tape within the deck unit, a grip cover is mounted to one side of the deck door, the deck door and the grip cover are movably positionable with respect to the outside surface of the main body for facilitating gripping of the apparatus by a user's hand; and
a plurality of prominences and depressions disposed on an outside surface of the grip cover, providing a gap between the user's hand and the outside surface of the grip cover for facilitating air flow.

17. The image photographing apparatus of claim 16, wherein the prominences and depressions comprise a plurality of ribs.

18. The image photographing apparatus of claim 16, wherein the deck door has a gripping cover mounting part on a side opposite the gripping cover side, the gripping cover mounting part has at least one adjustment hole extending therethrough for adjusting a magnetic tape travel system of the deck unit, and the adjustment hole is covered and uncovered by the grip cover.

19. The image photographing apparatus of claim 18, wherein the grip cover comprises:
a hook disposed thereon for engagement with the adjustment hole; and
a screw hole for releasably attaching the grip cover to the deck door by a fastener.
